(19) United States
(12) Patent Application Publication
(10) Pub. No.: US 2018/0136074 A1
(43) Pub. Date: May 17, 2018

(54) SYSTEM FOR FINDING SLAB LEAK LOCATION

(71) Applicant: James Kearns, Ft. Worth, TX (US)

(72) Inventor: James Kearns, Ft. Worth, TX (US)

(21) Appl. No.: 15/352,922

(22) Filed: Nov. 16, 2016

(51) Int. Cl. G01M 3/22

(52) U.S. Cl. CPC G01M 3/22

(57) ABSTRACT

A leak detection system configured to detect a plurality of leaks within a pipe line. The leak detection system comprising a tracer unit introduced into the pipe line, having a signal generator positioned within the tracer unit, and the signal generator configured to transmit a signal through the inner lining of the pipe line to detect a leak. A feedback transmitter is in communication with the signal generator to transmit any feedback from the signal generator to a hand-held sensor. The hand-held sensor comprises a user display interface. A signal transmission module transmits the signal to the feedback transmitter. The transmitted signal prompts the feedback transmitter to retrieve information regarding the location and magnitude of the leak. A signal receiver module will receive a feedback signal from the feedback transmitter and also display the feedback signal on the user display interface.

### FIELD OF THE INVENTION

The present invention relates to a method and system for detection of a slab leakage in structures, under concrete and specifically relates to a system for an electronically controlled leak detection and leak source locator.

### BACKGROUND OF THE INVENTION

A slab leak is a leak in the pipe under a concrete slab within the perimeter of a structure. Leaks under a driveway or under patios can also be referred to as slab leaks. When slab leaks occur, various different sounds may occur such as a “Hiss” or “Whoosh” sound caused by pipe vibration and orifice pressure reduction. “Splashing” or “Babbling Brook” sounds caused by water flowing around the pipe are also possible. Rapid “beating or thumping” sounds from water spray striking the wall of the soil cavity and small “clinking” sounds of stones and pebbles bouncing off the pipe are also sound indicators. Many attempts have been made to identify the particular sound in order to solve the type of leakage problem as it relates to a particular sound.

Presently known methods, such as those disclosed in U.S. Pat. Nos. 7,948,388, 6,225,909, 5,081,422 and 5,818,340, typically rely upon a moisture detector and water sensing device inside the water supply lines, or on a floor surface to identify whether or not water is moving through the supply lines or to identify where water is accumulating or getting clogged under the floor or under concrete surfaces.

There are several problems with these existing slab leak detection systems. Some are prone to identifying leaks falsely when there exists no leak at all. For example, detectors or sensors when located on the surface or on concrete may signal a leak erroneously. Moreover, devices or systems that monitor water flow underneath concrete structures can erroneously identify normal water use as a potential leakage.

There is a need, therefore, for an unobtrusive and reliable system and method for identifying and signaling leaks in slab structures in homes, condominiums, offices, mobile homes and other abodes. In particular, there is a need for a reliable system and method to identify and signal precisely the location of a slab leak.

### SUMMARY OF THE INVENTION

The present invention provides a leak detection system configured to detect a plurality of leaks within a pipe line. The leak detection system comprising a tracer unit introduced into the interior of any pipe line which contains a fluid flow, the tracer unit is configured to traverse along the fluid flow through the length of the pipe line. The tracer unit comprises a signal generator positioned inside the tracer unit with the signal generator configured to transmit a signal from within the pipe line to detect a leak location. A feedback transmitter is in communication with the signal generator to transmit the feedback from the signal generator to a hand-held sensor. The hand-held sensor comprises a user display interface. A signal transmission module is present inside the hand-held sensor unit such that the signal is transmitted to the feedback transmitter. The transmitted signal prompts the feedback transmitter to retrieve information regarding the location and magnitude of the leakage detected within inner lining of the pipe line. A signal receiver module is to receive any feedback signal from the feedback transmitter and will also display the feedback signal on the user display interface.

The tracer unit which includes the signal generator, feedback transmitter and a battery, is made from a Styrofoam® material configured to have a ball shaped cross-section. In an exemplary embodiment, the shape of the tracer unit is configured to have at least one of a spherical, ellipsoid and round cross-section.

In a preferred embodiment, the tracer unit is intended to roll along the bottom of the pipe line, as the ball shaped tracer unit rolls along the inner lining of the pipe line, with the force for its motion given by the moving fluid in the pipe line. For the tracer unit to stay at the bottom of the pipe line, its overall density is made greater than the density of the liquid with which the pipe line is filled.

In a preferred embodiment of the present invention, the tracer unit is smaller in diameter and cross-section than the pipe line, and therefore the tracer unit does not hinder the flow of liquid within the pipe line while moving inside the inner lining of the pipe line. The tracer unit size does not create significant back pressure or impede the flow of liquid inside the pipe line.

### BRIEF DESCRIPTION OF DRAWINGS

FIG. 1 illustrates the schematic representation of the leak detection system incorporating the aspects of the present invention.

FIG. 2 illustrates a hand-held sensor unit of the leak detection system incorporating the aspects of the present invention.

FIG. 3 illustrates the deployment of a tracer unit for leak detection inside a water heater pipe line incorporating the aspects of the present invention.

FIG. 4 illustrates the deployment of the tracer unit inside the pipe line of the leak detection system and a user operating a hand-held sensor unit incorporating the aspects of the present invention.

### DETAILED DESCRIPTION OF THE INVENTION

The following detailed description of the different exemplary embodiments presents a description of certain specific embodiments to assist in understanding the claims. However, the present invention is intended to cover alternatives, modifications and equivalents, which may be included within the spirit and scope of the invention as defined by the appended claims.

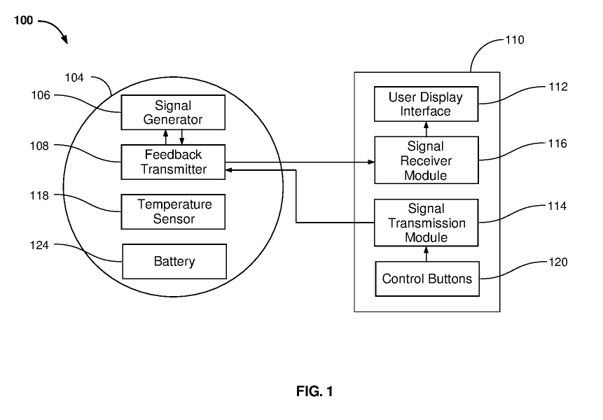

According to FIG. 1 which illustrates one preferred embodiment of a leak detection system 100 comprising a tracer unit 104 and a hand-held sensor unit 110. A wireless communication is established between the tracer unit 104 and the hand-held sensor unit 110. The tracer unit 104 comprises a signal generator 106 and a feedback transmitter 108. Further the tracer unit comprises a temperature sensor 118 and a battery 124. The hand-held sensor unit 110 comprises modules such as a user display interface 112 and a signal transmission module 114 and a signal receiver module 116 and a control button 120. In order to determine the leakage in a pipe line 102, a user activates the control button 120 of the hand-held sensor unit 110 and the communication starts by passing the signal to the signal transmission module 114. The signal transmission module 114 transmits the signal to the feedback transmitter 108 of the tracer unit 104. Further, the feedback transmitter 108 transmits the signal to the signal generator 106 and the signal generator 106 transmits the signal to a inner lining of the pipe line 102. The signal generator 106 receives a feedback signal from the pipe line 102 and transmits the feedback signal to the signal receiver module 116 via the feedback transmitter 108. The feedback signal received by the signal receiver module 116 is analyzed and output is sent to the user display interface 112.

According to a preferred embodiment of FIG. 1, the leak detection system 100 configured to detect a plurality of leakages within the pipe line 102 is shown. The tracer unit 104 in the leak detection system 100 is configured such that it can roll into the pipe line 102 which contains a fluid flow and traverses along the fluid flow through the length of the pipe line 102. The signal generator 106 positioned within the tracer unit 104 transmits the signal from within the pipe line 102 to detect the leakage. The temperature sensor 118 is configured to sense the temperature of fluid flow inside the pipe line 102. The battery 124 is configured inside the tracer unit 104 to power the signal generator 106 and the feedback transmitter 108. The battery 124 can be rechargeable batteries or any other self-contained energy source of a suitable size.

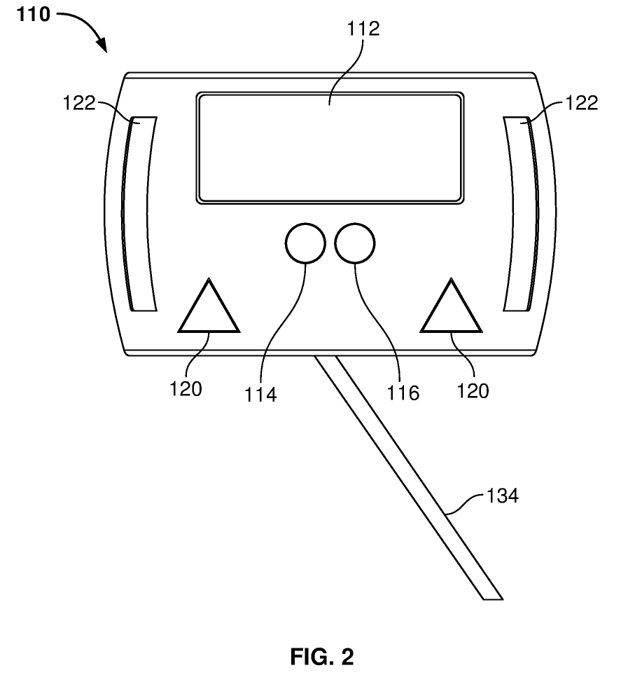

According to FIG. 2, the hand-held sensor unit 110 comprises the user display interface 112, the signal transmission module 114 and the signal receiver module 116. The signal transmission module 114 transmits the signal to the feedback transmitter, wherein the transmitted signal prompts the feedback transmitter 108 to retrieve information regarding the location and magnitude of the leakage detected within inner lining of the pipe line 102. The signal receiver 116 module is to receive the feedback signal from the feedback transmitter 108, and display the feedback signal on the user display interface 112. Using the control button 120 in the hand-held sensor unit 110, different parameters such as location, magnitude, temperature, depth, light, power etc. can be selected and displayed in the user display interface 112. The control button 120 acts as a reset button on the hand-held sensor unit 110. If this button is activated or pressed, all the parameters are reset. For example, all the previously detected parameters are set to zero if the reset button is depressed. The hand-held sensor unit 110 further comprises a gripping member 122 to hold the hand-held sensor unit 110 rigidly during activation. Additionally, the hand-held sensor unit 110 further comprises a handle 134 or other ergonomically advantageous holding element for improved holding capability. In a preferred embodiment, the hand-held sensor unit 110 further acts as a beacon locator for leak detection.

According to the preferred embodiment, the tracer unit 104 is configured to have less weight than the fluid in the pipe line 102, as it is intended to move along the inner lining of the pipe line 102. In the present invention, the tracer unit 104 cover is made of material such as Styrofoam® which is an expanded plastic made from polystyrene. The Styrofoam® ball houses internally the signal generator 106 and the feedback transmitter 108. However, the tracer unit 104 can also be made from rigid material, such as a thick plastic or a metal which should not effect the outer covering of the tracer unit 104. The tracer unit 104 is sized to have a small diameter and cross-section such that any valve or access port in the upper surface of the pipe line 102 should not stop the movement of the tracer unit 104. The predefined diameter of the tracer unit 104 is configured to be less than that of the pipe line 102 to be inspected.

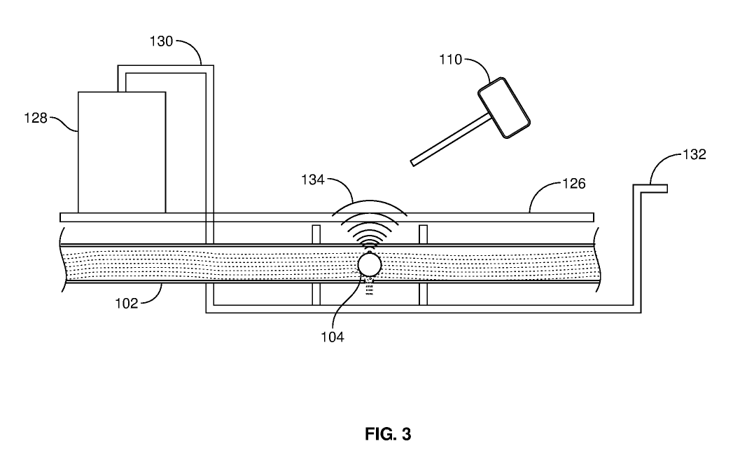

According to FIG. 3, which illustrates the deployment of the tracer unit for leak detection in the pipe line of a water heater incorporating the aspects of the present invention. A slab member 126 covers the pipe line 102 and there exists an insertion point 130 for the flow of water into a water heater 128. The tracer unit 104 passes along the water to detect a leak source and transmits the signal 134 to the hand held sensor unit 110. The transmitted signal 134 is a beacon signal sending the location of the tracer unit 104 and detecting the exact position of the leak in the pipeline 102. The tracer unit 104 is made up of material such as Stryofoam® which is configured to fit inside the pipe line 102 and travel along the path of the water flow. The tracer unit 104 components are configured such that it will not offset the balance of the tracer unit 104. The water flows through the pipe line 102 and reaches the retrieval point 132 and if a leak occurs between the insertion point 130 and the retrieval point 132, the leak detection system 100 detects and transmits the location of the leak to the hand-held sensor unit 110 which displays various parameters of the beacon signal 134.

According to the preferred embodiment, the signal generator 106 in the tracer unit 104 transmits a signal through the inner lining of the pipe line at pre-defined time intervals. This permits the user to keep track of the progress of the tracer unit 104. The signal generator 106 emits frequencies higher than the audible range, preferably frequencies above 40 to 90 KHz. The signal generator 106 is also configured to emit a beacon signal. Since higher frequencies tend to propagate very long distances in a pipe line, the feedback transmitter 108 emits at least one frequency above 20 KHz. The feedback transmitter 108 transmitted signal can also be an acoustic signal.

According to the preferred embodiment, the tracer unit 104 is inserted into the pipe line 102 in any form, for example, in a collapsed form. Since the tracer unit 104 is made up of Styrofoam®, the tracer unit 104 is compressed when it goes into a hot water line. If the leakage suspection is identified in a hot water line, the user disconnects the supply line from the water heater. In order to determine the type of leak such as a cold or hot leak, a temperature sensor can be used. The tracer unit 104 is preferably round, spherical, ellipsoid or any shape made in a small shape to travel inside the pipe line 102. The tracer unit 104 has a larger resistance to water flow, making it easier for the water to push through the pipe line 102.

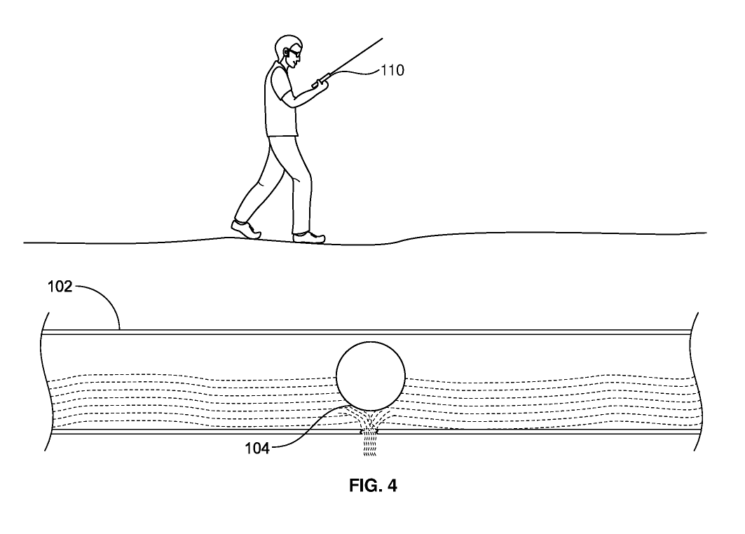

According to FIG. 4, displays a tracer unit 104 moving through the pipe line. In the embodiment shown, the tracer unit 104 is denser than the liquid inside the pipe line. The tracer unit 104 rolls along the bottom of the pipe line 102. If it is suspected that a leak is present, the signal transmission module 114 transmits a signal to the feedback transmitter 108 using the control button 120. The signal from the feedback transmitter 108 of the tracer unit 104 are transmitted through the inner lining of the pipe line via the signal generator 106. The feedback signal from the feedback transmitter 108 is received by the signal receiver module 116 and the parameters of the feedback signal are displayed in the user display interface 112. Analysis is completed quickly and the leak location is detected in the pipe line 102.

Turning to FIG. 4, an embodiment of the present invention includes the hand-held sensor unit 110 and the tracer unit 104 inside a pipe line 102. In FIG. 3, the hand-held sensor unit 110 and the tracer unit 104 may be connected by wireless protocol. For example, the user display interface 112 serves to display information relating to the pipe inspection system. The user display interface 112 is selected from the group consisting of LCD display device, LED display device and a keypad device.

According to the preferred embodiment, the tracer unit 104 also comprises a suitable power supply such as the battery 124 to power the signal generator 106 and the feedback transmitter 108. A non-rechargeable lithium battery is currently preferred but it is also possible to use any other battery or other power supply which delivers a suitable voltage to power the entire tracer unit 104 for the intended period of use.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

1. A leak detection system configured to detect a plurality of leaks within a pipe line, the leak detection system comprising;
a tracer unit introduced into the pipe line which contains a fluid flow, the tracer unit configured to traverse along the fluid flow through the length of the pipe line, the tracer unit comprising:
a signal generator positioned within the tracer unit, the signal generator configured to transmit a signal through the inner lining of the pipe line to detect a leak within the pipe line; and
a feedback transmitter in communication with the signal generator to transmit feedback from the signal generator to a hand-held sensor unit;
the hand-held sensor unit comprising;
a user display interface;
a signal transmission module to transmit a signal to the feedback transmitter, wherein the transmitted signal prompts the feedback transmitter to retrieve information regarding the location and magnitude of the leakage detected within inner lining of the pipe line; and
a signal receiver module to receive a feedback signal from the feedback transmitter, and display the feedback signal on the user display interface.

2. The leak detection system of claim 1, further comprising a temperature sensor to sense the temperature fluid flow inside the pipe line.

3. The leak detection system of claim 1, wherein the feedback transmitter transmits an acoustic signal.

4. The leak detection system of claim 3, wherein the feedback transmitter emits at least one frequency above 20 KHz.

5. The leak detection system of claim 1, wherein the tracer unit comprises a Styrofoam® ball that internally houses the signal generator and the feedback transmitter.

6. The leak detection system of claim 1, wherein the signal generator emits a predetermined frequency range between 40 to 90 KHz.

7. The leak detection system of claim 1, further comprising a battery to power the signal generator and the feedback transmitter.

8. The leak detection system of claim 1, wherein the tracer unit is configured to have a predefined diameter less than the diameter of the pipe line to be inspected.

9. The leak detection system of claim 1, wherein the user display interface is selected from the group consisting of LCD display device, LED display device and a keypad device.

10. The leak detection system of claim 1, wherein the communication is established between the tracer unit and the hand-held unit via a wireless protocol.
